(19) United States
(12) Patent Application Publication
(10) Pub. No.: US 2009/0183590 A1
(43) Pub. Date: Jul. 23, 2009

(54) DEVICE FOR PREVENTING TIRE RIM DAMAGE FROM A CARWASH CONVEYOR TRACK GUIDE RAIL

(76) Inventor: Clarence McGhee, East Windsor, NJ (US)

Correspondence Address: NW-IP-LAW, 6039 E. Grant RD., Tucson, AZ, 85712, US

(21) Appl. No.: 12/016,078

(22) Filed: Jan. 17, 2008

(51) Int. Cl. G05G 5/06

(52) U.S. Cl. 74/527

(57) ABSTRACT

The present invention features a device for preventing the front wheels from turning left and/or biasing front wheels of a car to the right during transport through a carwash conveyor track. In some embodiments, the device comprises a grip which is attached to a weight.

### BACKGROUND OF THE INVENTION

In an automated car wash system, a car is placed on a conveyor track so that the car can be pushed through the tunnel to be washed. At the beginning of the conveyor is a device called a correlator. This is simply a series of wheels or rollers that allow the left wheels (front and back) of the car to slide sideways until it is aligned with the conveyor. Once the front left wheel of the car is within the conveyor track, small rollers pop up behind the wheel. The roller pushes the wheel forward, causing the car to roll along through the tunnel, long bay used for exterior-only and full-service systems.

Generally, there are two standard types of conveyor systems. One is the front-wheel pull, which engages and pushes on the front left wheel thereby pulling the car along. The other is the rear-wheel push, which engages and pushes on the rear left wheel thereby pushing the car along. In either conveyor system, the car tends to move towards the left guide rail of the conveyor track as the car is pulled or pushed through the conveyor track.

The problem with the car tending to move towards the left rail of the conveyor track is that the tire rims, especially the front left rim, can be scratched and damage by the left guide rail of the conveyor track.

The present invention provides a device and use thereof for preventing damage to tire rims for cars moving through the conveyor track. Further, the present device can be used to prevent staining to the white portion of the tire for cars moving through the conveyor track.

### BRIEF DESCRIPTION OF THE DRAWINGS

FIG. 1 shows a device of the present invention comprising a grip and a weight.

FIG. 2 shows a cross section of the grip (e.g., hook) where there is a soft outer coating.

FIG. 3 shows a device of the present invention being placed onto the steering wheel to bias the steering wheel and the wheel of the car to the right.

FIG. 4 shows a conveyor track (with a left and right guard rail) commonly employed in a carwash facility.

FIG. 5 shows a car on a conveyor track where the wheels turn left and the left front tire rim being scratched against the left guard rail.

FIG. 6 shows a car on a conveyor track where the wheels turn right and the left front tire rim is kept away from the left guard rail.

FIG. 7 shows a steering wheel turned at an angle.

FIG. 8 shows weights of various sizes, where the heavier one is shown on the left and the lighter one is on the right.

### DESCRIPTION OF PREFERRED EMBODIMENTS

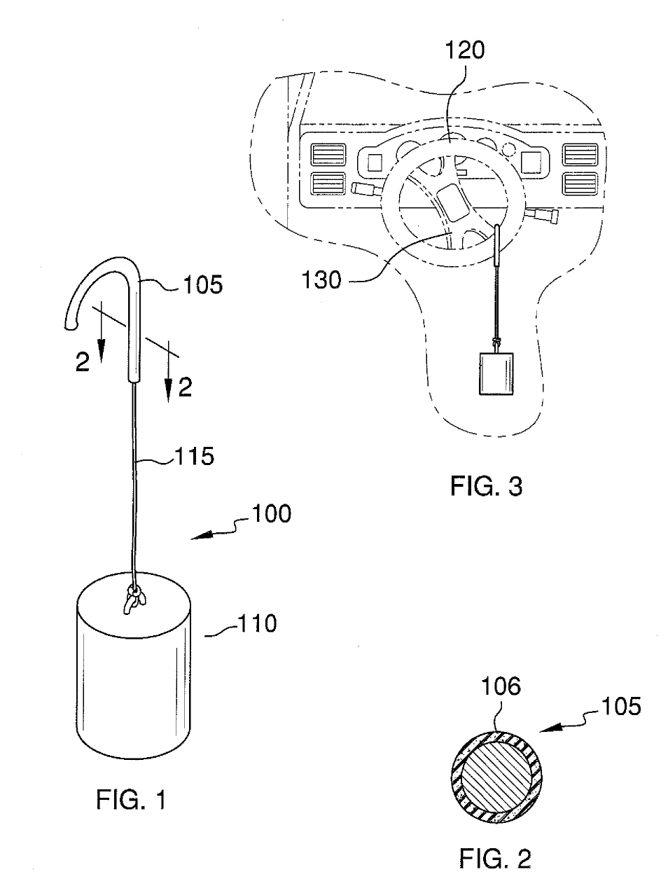

The present invention features a device 100 for preventing the front wheels of a car from turning left and/or biasing front wheels 150 of a car to the right during transport through a carwash conveyor track 200 (see FIG. 4). In some embodiments, the device 100 comprises a grip 105 which is attached to a weight 110. (FIG. 1).

In some embodiments, the grip 105 has a hook shape so that it can be temporarily secured to a steering wheel 120 of a car (see FIG. 1). In some embodiments, the grip 105 is constructed from a hard material, e.g., metal, rigid plastic, glass, and the like. In some embodiments, the grip, e.g., hook, is coated with a soft material 106, e.g., rubber, fabric, and the like, to prevent the grip 105 from damaging by the steering wheel 120.

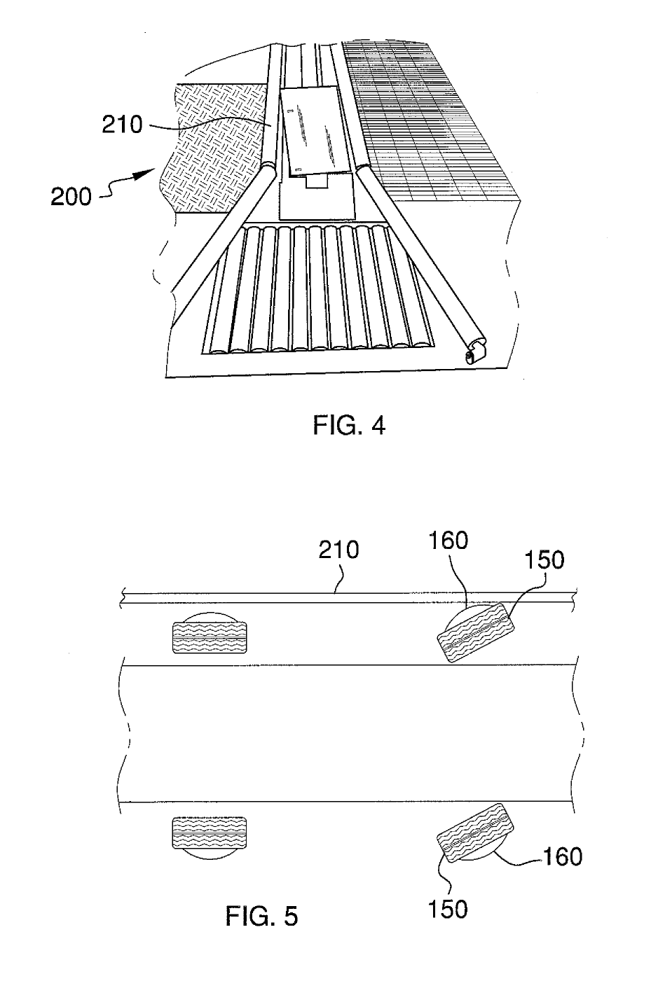

The grip 105 is placed onto the steering wheel 120 in a manner where the weight 110 is effective to prevent the steering wheel from turning left and/or effective to turn the steering wheel 120 to the right and thereby preventing the front wheel from turning left and/or biasing the front wheels 160 of the car to the right (see FIG. 3). As used herein, to prevent the steering wheel from turning left and/or to prevent the front wheels from turning left means to maintain the steering wheel at a position where the front wheel would be aligned parallel to or deviating to the right relative to the front/back axis of the car. For example, the grip 105 is placed onto the right side of the steering wheel 120 as shown in FIG. 3, resting at the edge formed by the steering wheel 120 and a steering wheel connector 130 (the “right” side of the steering wheel 120 is with respect to the person sitting in the driver seat and facing the front windshield).

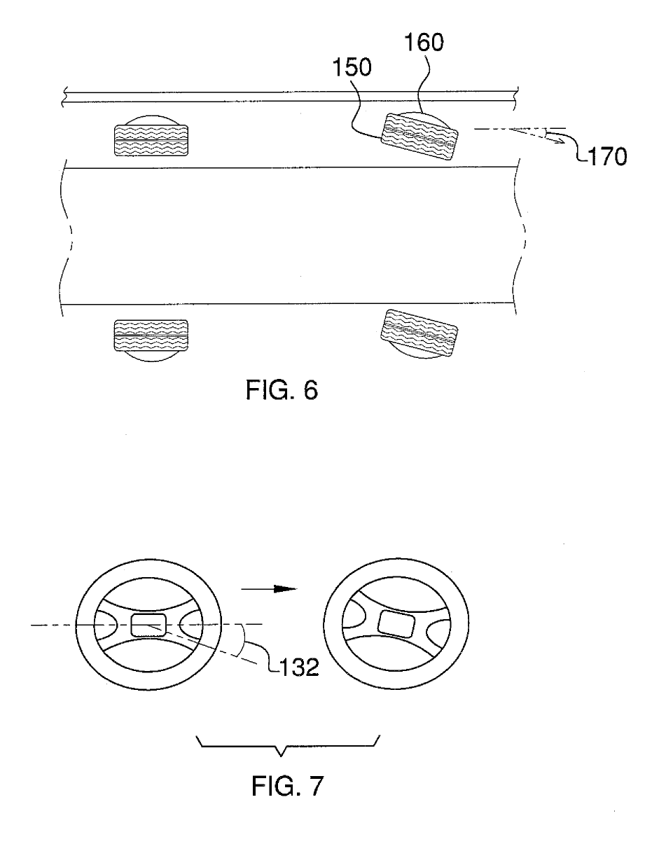

Without the device 100, a car tends to move towards the left guard rail 210 of the conveyor track 200 as the car is being pushed along the conveyor track 200. As such, a tire rim 160 may scratch against and be damaged by the left guard rail 160 (see FIG. 5). Scratching/damaging of tire rims is especially a problem for cars outfitted with 18-24 inch rims extending beyond the rubber tires. In some embodiments, the device 100 when temporarily secured to a steering wheel 120 as shown in FIG. 3, is effective to prevent the front wheels 150 from steering to the left, i.e., maintaining the front wheels at an angle 170 of between about 0 degrees to about 10 degrees to the right (FIG. 5). In some embodiments, the device 100 when temporarily secured to a steering wheel 120 as shown in FIG. 3, is effective to turn the front wheels 150 at an angle 170 of between about 2 degrees to about 10 degrees to the right (see FIG. 5), for example, about 3-5 degrees to the right. (As used herein, the term “about” means plus or minus 10%). As such, the car will tend to move straight or towards the right guard rail 210 of the conveyor track 200 as the car is being pushed along the conveyor track 200. As the car moves and stays straight or towards the right guard rail, or away from the left guard rail 210, the tire rim 160 would not come into contact with the left guard rail 210 and would not be scratched and damaged by the left guard rail 210 (see FIG. 6).

In some embodiments, the device 100 when temporarily secured to a steering wheel 120, is effective to maintain the steering wheel in a position where the front tires are parallel to the front/back axis of the car. In some embodiments, the device 100 when temporarily secured to a steering wheel 120, is effective to turn the steering wheel 150 at an angle 132 of between about 5 degrees to about 60 degrees to the right (see FIG. 6), for example, about 20 to 40 degrees. As used herein, it is assumed that when the steering wheel angle 132 is 0 degrees, the front wheel angle 170 is also 0 degrees.

In some embodiments, the device 100 when temporarily secured to a steering wheel 120, is effective to maintain the steering wheel 150 at an angle 132 of about 0 degrees as the car is being pushed through the conveyor track 200 (see FIG. 6). That is, as the car is being pushed through the conveyor track 200 the car tends to move towards the left guard rail 210 (and the steering wheel would accordingly turn to the left or counter clockwise). In this embodiment, the device 100 is temporarily secured to the steering wheel 120 to prevent the car steering wheel from turning to the left. For example, the device 100 can be temporarily secured on the right side of the steering wheel 120 to provide a counter weight to the steering wheel that is turning left, to reposition the steering wheel to about a 0 degree angle 132 (0 degrees as shown in FIG. 6) to allow the car to move through the conveyor track 200, wherein the car moves straight forward (not drifting to the left nor the right).

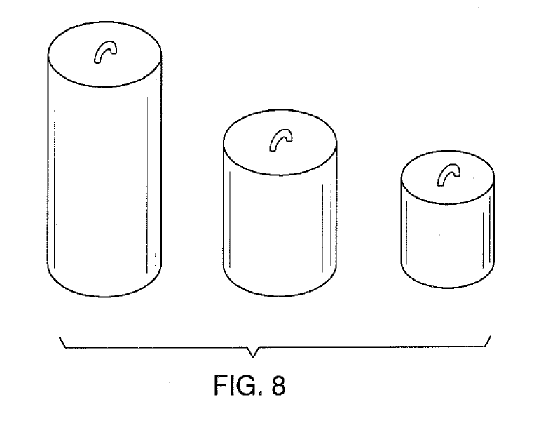

In some embodiments, the weight 110 is attached to the grip directly. In some embodiments, the weight 110 is attached to the grip indirectly through a string 115. In some embodiments, the string can be tied or glued (attached) to the grip 105 and/or the weight 110 (see FIG. 1). In some embodiments, the weight 110 is about 3.5 pounds to about 8 pounds. In some embodiments, a grip 105 attached to a string 115 can be tied to a variety of weight 110 (FIG. 8). For example, a string 115 attached to a grip 105 can be tied to a 3 pound weight or an 8 pound weight.

In some embodiments, the weight with the lighter pounds (e.g., 3.5 pounds) is used on steering wheels of smaller cars or steering wheels that are lighter to turn (e.g., Cadillac and Lexis tends to have lighter turning steering wheels). In some embodiments, the weight with the heavier pounds (e.g., 8 pounds) is used on steering wheels of larger cars (SUV/CUV crossed over utility vehicles and trucks) (BMW cars tend to be stiffer turning steering wheels).

In some embodiments, the weight with the lighter pounds (e.g., 3.5 pounds) is used on steering wheels 120 that are “light”, e.g., easy to turn. In some embodiments, the weight with the heavier pounds (e.g., 8 pounds) is used on steering wheels 120 that are “heavy”, e.g. steering wheels not facilitated with power steering.

In some embodiments, the weight 110 is coated with a soft cover (e.g., rubber, plastic, fabric, and the like). In some embodiments, the weight is brightly colored (e.g., yellow, red, orange, etc.).

The present invention also includes a method of using the inventive device 100. In some embodiments, a carwash operator places the present device 100 onto the steering wheel 120 of a car (as described above) prior to the car being pushed through the conveyor track 200 of a carwash system. After the car exits the conveyor track 200, a carwash operator removes the present device 100 from the steering wheel 120.

Various modifications of the invention, in addition to those described herein, will be apparent to those skilled in the art from the foregoing description. Such modifications are also intended to fall within the scope of the appended claims. Each reference cited in the present application is incorporated herein by reference in its entirety.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims.

What is claimed is:

1. A device for preventing the front wheels of a car from turning left during transport through a carwash conveyor track, the device comprising a grip attached to a weight, wherein the grip is placed onto a steering wheel of the car in a manner where the weight is effective to prevent the steering wheel from turning left and thereby preventing the front wheels of the car from turning left.

2. The device of claim 1 wherein the grip is a hook.

3. The device of claim 1 wherein the weight is about 3.5 to about 8 pounds.

4. The device of claim 1 wherein the grip is attached to the weight by a string.

5. A device for biasing front wheels of a car to the right during transport through a carwash conveyor track, the device comprising a grip attached to a weight, wherein the grip is placed onto a steering wheel of the car in a manner where the weight is effective to turn the steering wheel to the right and thereby biasing the front wheels of the car to the right.

6. The device of claim 1 wherein the grip is a hook.

7. The device of claim 1 wherein the weight is about 3.5 to about 8 pounds.

8. The device of claim 1 wherein the grip is attached to the weight by a string.
